(19) United States
(12) Patent Application Publication
(10) Pub. No.: US 2012/0225202 A1
(43) Pub. Date: Sep. 6, 2012

(54) METHOD OF PRODUCING A POROUS MEMBRANE AND WATERPROOF, HIGHLY BREATHABLE FABRIC INCLUDING THE MEMBRANE

(76) Inventor: Dah Yu Cheng, Los Altos Hills, CA (US)

(21) Appl. No.: 13/471,755

(22) Filed: May 15, 2012

Related U.S. Application Data
(62) Division of application No. 11/644,584, filed on Dec. 21, 2006, now abandoned.
Application No. 11/644,584 is a division of application No. 10/872,118, filed on Jun. 17, 2004, now abandoned.
(60) Provisional application No. 60/480,143, filed on Jun. 19, 2003.

(51) Int. Cl. B05D 5/00

(52) U.S. Cl. 427/243

(57) ABSTRACT

A method for creating a highly breathable and waterproof fabric based on hydrophobic plastic (such as PVDF) as a membrane layer. This new fabric allows higher water vapor throughput and better water resistance than other PVDF and ePTFE membranes. This is achieved through control of pore size, thus creating a spongy porous structure, pre-stressing to make the membrane and subsequent laminated fabric soft, and a microscopically folded structure which increases the surface area for the porous media, thus gaining higher throughput, waterproofness and comfort. In addition, the invention provides a method of controlling pore size distribution, increased porosity and pre-stress relief during the gelation process.

### CROSS REFERENCE TO RELATED APPLICATION

This application is a division of copending application Ser. No. 11/644,584 filed Dec. 21, 2006, which is a division of application Ser. No. 10/872,118 filed Jun. 17, 2004, which claims the benefit of U.S. provisional patent application No. 60/480,143 filed Jun. 19, 2003, under 35 U.S.C. §119(e).

### BACKGROUND OF THE INVENTION

1. Field of the Invention

This invention relates to methods of making porous polymeric membranes, in particular hydrophobic membranes, and to products of such methods. In an important aspect, it is directed to membrane-producing methods incorporating control of physical properties such as pore dimension, density, and pre-stress characteristics (including flexibility) of a membrane using highly hydrophobic plastics as the porous layer to create a waterproof and highly breathable fabric, as well as to fabrics thereby produced.

Highly breathable and waterproof fabric currently is based on a “Teflon”® polymer membrane as the hydrophobic layer as in “Gore-Tex”® fabrics, or on other materials such as polyurethane. “Teflon”® polymer is the most hydrophobic material available but no solvent can dissolve it so the porous membrane structure is made by physically stretching a thin “Teflon”® sheet several times while heated, forming a fibrous structure, and then overlaying several such sheets to create a porous membrane. Other methods of creating the porous membrane out of “Teflon”® sheets can provide control of maximum pore diameter and density but are not as breathable as the “Gore-Tex”® membrane. The cost of making the “Gore-Tex”® type membrane is very high.

Other materials such as polyurethane can use a solvent-based knife spreading and baking process. Polyvinylidene fluoride (PVDF) is the next best hydrophobic material after “Teflon”® polymer and it does have a limited number of solvents. This means that a traditional solvent/non-solvent process as described by Michaels (U.S. Pat. Nos. 3,615,024 and 6,112,908) can be used to make the membrane. There are many parameters relevant to this being explored in industrial laboratories. The non-solvent has to be highly miscible with the solvent to reduce the leaching time. Alcohol based non-solvents are very popular among membrane makers. Water can be used at elevated temperature to increase its miscibility with solvents and thus reduces gelation time.

Heretofore, however, no attention has been paid to stress relief of the porous membrane. During its production, the PVDF membrane is stressed and becomes brittle and therefore likely to break after many folding actions, thus disqualifying it as a suitable hydrophobic layer for a fabric. Other materials do not have comparable hydrophobic characteristics. PVDF has a very low surface tension, only slightly more than “Teflon”® polymer. “Teflon”® polymer has a surface tension of 18 dynes/cm and PVDF 25 dynes/cm. These materials are far superior to any other material (for example: polyurethane). A PVDF membrane can be constructed to have a vacuole pocket structure underneath a thin top layer, which gives it an extended surface area for water vapor passage, making it potentially more breathable than the Gore membrane without having to have larger pore sizes on the skin layer. Smaller pores improve waterproofness. None of the prior art discloses a method of controlling the texture of the membrane which is usually hard and brittle and therefore unsuitable for use as the hydrophobic layer of a breathable and water proof fabric.

2. Description of Prior Art

All porous membranes manufactured using the solvent/non-solvent process follow in large part the teaching of U.S. Pat. No. 3,615,024 (Michaels '024), which describes (see FIG. 1 of the patent) the relationship of solvent and non-solvent with solids and the process to follow for the gelation of a porous membrane. However, the patent does not mention that there is a pre-stress problem during the gelation step, which influences the pore structure and the flexibility of the membrane. At the time of Michaels '024 a porous membrane with a thin skin using cellulose acetate and cellulose nitrate for reverse osmosis already existed. The reverse osmosis membrane of that time was stiff and breakable when dry and soft and elastic when wet, and could absorb large quantities of water. In particular, Michaels '024 was concerned with low temperature thermal distillation of seawater. There was no need to address the pre-stress relief of the hydrophobic membrane.

U.S. Pat. Nos. 3,240,683 and 3,406,096 (Rodgers) are directed to thermal distillation using a hydrophobic membrane. These Rodgers patents specify that the pore diameter should be in the range of 1.0 to 2.0 micron, but do not teach how to make the membrane. They mention that the pore diameter if too small would impede the vapor flow throughput and if too large the hydrostatic pressure on the membrane surface would force water through. No mention is made of stress relief of the membrane during the gelation process.

As set forth in U.S. Pat. No. 4,265,713 (Cheng) and U.S. Pat. Nos. 4,419,242, 4,316,772 and 4,419,187 (Cheng et al.), the present applicant discovered that the hydrophobic membrane should be covered by a thin hydrophilic layer which prevents seawater penetration into the hydrophobic pores. The hydrophilic layer covering the opening of pores also prevents contamination by oils and other wettable agents which would cause the hydrophobic pores to be penetrated by liquids. No mention of membrane pre-stress relief is made in these prior patents.

U.S. Pat. No. 6,112,908 (Michaels '908) refers to the composite layer structure of the aforesaid U.S. Pat. Nos. 4,419,242 and 4,419,187. The numerous references of record in Michaels '908 deal with the composite membrane structure for thermal distillation of salt water.

U.S. Pat. Nos. 3,962,153 and 4,187,390 (Gore) relate to stretched “Teflon”® (tetrafluoroethylene polymer) porous membranes, with which a hydrophilic layer may be employed, using a Hyper-A glue layer as the hydrophilic material.

U.S. Pat. No. 6,146,747 (Wang et al.) for liquid filtering uses PVDF membrane as a substrate. This is because PVDF can prevent a large number of chemicals from attacking the material or dissolving it. However, owing to the hydrophobic property of PVDF, the filter needs a wetting agent such as alcohol to penetrate the pores first and this is then followed by the liquid that is being filtered. This restricted the application of the PVDF as a micro filter. The Wang et al. patent describes adding a small quantity (less than 2%) of hydrophilic polymer such as PVP to the PVDF solution with DMAC as solvent, then going through the solvent/non-solvent gelation process of Michaels, to obtain a PVDF based membrane with a hydrophilic property without using a wetting agent to initiate liquid filtration. No mention is made of porous membrane stress relief.

U.S. Pat. No. 6,126,826 (Pacheco et al.) describes a control process for making membranes using a solvent and a small amount of co-solvent, which is then replaced with a solvent/non-solvent mixture. The patent states that the pore size of the membrane can be controlled by the temperature of the solution, and also that the pore structure is simpler, which means that the pressure drop would be smaller for the same fluid flow rate. Again, there is no mention of pre-stress relief in the described process and product. The patent states further that a low-pressure drop is irrelevant to thermal vapor throughput in that the pressure drop is so small that the flow is not controlled by the pressure differential but by the relative humidity and porous density of the membrane. That is why a thin coating of a hydrophilic material covering all the holes did not change the vapor flow rate significantly.

U.S. Pat. No. 4,863,788 (George L. Bellairs, Chris E. Nowak and Mahner Parekh) describes a complicated multi-layer membrane. It contains no teaching on control of flexibility and pore size and distribution by adjustment of surface tension of non-solvent bath.

### SUMMARY OF THE INVENTION

Stated broadly, an object of the present invention is to provide new and improved methods for producing porous membranes, in particular hydrophobic membranes, by a solvent/non-solvent process controlled to develop desired membrane properties such as pore characteristics and flexibility.

Another object is to provide a waterproof fabric including a woven or non-woven backing on a thin porous hydrophobic and preferably PVDF membrane having controlled pore size distribution for waterproofness and high vapor throughput for comfort. An additional object is to provide such a fabric which is soft with good “hand,” achieved by controlled pre-stress relief of the porous structure during its formation

Further objects are to make a hydrophobic porous membrane that resists water penetration at least to a water pressure equivalent to that of a 60 MPH storm hitting a hat, cloth jacket, shoes, etc., without penetrating the fabric; to make a hydrophobic porous membrane that can pass water vapor under typical human body and ambient temperatures at a rate similar to that of, or better than, “Teflon”® ePTFE membranes with fabric and hydrophilic coating, viz., a membrane that can pass water vapor under such conditions in a range of 4000 g/m²/day to 10,000 g/m²/day; to provide a hydrophobic porous membrane that is soft enough to provide comfort as a cloth, i.e., characterized by good “hand” as that term is used in the clothing industry; and to provide such a porous membrane made of hydrophobic material second only to “Teflon”® polymer in hydrophobicity.

Yet another object is to be able to coat such a membrane on a woven or non-woven fabric without the use of a glue layer or minimum requirement for this glue layer.

Other objects are to provide such a membrane having a very thin hydrophilic layer coated over its pores without impeding the breathability of the material, thereby to improve waterproofness so that the membrane can withstand rain with a wind velocity of 60 to 100 mph; to provide such a membrane wherein the hydrophilic layer is attached to a loose net material to prevent mechanical rubbing of the membrane surface; and to provide such a membrane wherein the pores are 50 to 3000 nanometers in diameter.

An additional object is to control the softness of the membrane by pre-stressing it during the gelation process of membrane formation. This can be done by selection of different PVDF products as follows: Kynar homopolymer 460, 1000 series, 700 series and 370; Kynar copolymer 2500 series, 2750/2950 series, 2800/2900 series, 2850 series, and 3120 series, Solef 1015, Solef 21216, Solef 6020, Solef 3108, Solef 3208, Solef 8808, Solef 11008, Solef 11010, Solef 21508, Solef 31008, Solef 31508, Solef 32008, Solef 60512, Solef 1006, Solef 1008, Solef 1010, Solef 1012, Solef 1015/0078, Solef 6008, Solef 6010, Solef 6012, Hylar 301F, Hylar 460/461, Hylar 5000.

Another object is to provide such a membrane incorporating a small quantity of a fluorine-containing elastomer, e.g., “Viton”® fluoroelastomer, as an additive (not as a plasticizer) or such materials as long chain di-carboxylic acid esters with a “springy” structure, such as Dibutyl sebacate, Dioctyl adipate and others, in PVDF material for additional elasticity and further softness.

To these and other ends, the present invention in a first aspect broadly contemplates the provision of a method of producing a porous membrane, comprising providing a solution of a membrane-forming polymer in a solvent therefor, establishing a film of the solution, and bringing a liquid material including a non-solvent for the polymer into contact with the film so as to leach solvent from the solution and cause gelation of the polymer to form the membrane, wherein the improvement comprises controlling stress to which the membrane is subjected during gelation for developing at least one preselected physical property (e.g., softness or a porosity characteristic) in the formed membrane.

In important particular embodiments, the step of controlling stress comprises subjecting the membrane to compression stress during gelation. Compression stress during gelation (also sometimes referred to herein as compression pre-stress of the membrane) renders the membrane non-brittle, soft and flexible, and also tends to reduce pore size.

The step of controlling stress during gelation is advantageously performed by controlling surface tension of the liquid material (i.e., the non-solvent) in relation to that of the solution. Thus, the liquid material can be a mixture of at least two liquids and the surface tension of the liquid material can be controlled by selection of relative proportions of the two liquids in the liquid material. When the liquid material has a surface tension greater than that of the solution, the membrane is subjected to compression stress during gelation. The surface tension of the liquid material (non-solvent) may be selected, for a given solvent/non-solvent system, to provide desired softness or flexibility of the produced membrane and at the same time to enable attainment of a pore size sufficient for satisfactory breathability (gas flow through the membrane).

If the non-solvent surface tension is less than that of the solution, the membrane is subjected to tension stress during gelation (tension pre-stress), rendering the produced membrane brittle, with larger pores than in the case of compression pre-stress. The term “stress relief” is used herein to refer particularly to selection of non-solvent surface tension, in a given solvent/non-solvent system, such as to prevent or reduce tension pre-stress. If the solvent and non-solvent have the same surface tension, however, there is no stress on the membrane during gelation, with the result that channels for gas flow through the membrane fail to connect.

In the method of the invention, as embodied in the procedures herein described, the polymer forms a hydrophobic membrane, and the solvent and non-solvent are miscible. Very preferably, the polymer is PVDF. The solution may also include a fluorine-containing elastomer in an amount such that the formed membrane contains a minor proportion of the elastomer. The solvent may, for example, be DMAC or DMSO; the non-solvent may comprise a mixture of water and at least one of methanol and ethanol. In the latter case, non-solvent surface tension is increased or decreased, respectively, by increasing or decreasing the proportion of water relative to methanol or ethanol. For instance, the relative proportions of water and methanol or ethanol may be such that the liquid material has a surface tension greater than that of the solvent, thereby subjecting the forming membrane to compression stress during gelation.

The invention in a specific sense embraces a method of producing a soft, waterproof, breathable fabric, comprising providing a solution of PVDF in a solvent therefor, establishing a film of the solution, and bringing a liquid material including a non-solvent for PVDF into contact with the film so as to leach solvent from the solution and cause gelation of PVDF to form a porous hydrophobic membrane, the solvent and non-solvent being miscible, wherein the liquid material has a surface tension greater than that of the solution, such that the membrane is subjected to compression stress during gelation. In certain advantageous or preferred embodiments, the film is established by coating the solution on a fabric that is slightly soluble in the solvent, thereby fixing the produced membrane on the fabric without use of an adhesive. Further, this method includes the step of applying a thin hydrophilic layer over a surface of the produced hydrophobic membrane. Also, as mentioned above, a fluorine-containing elastomer may be included in the solution such that the produced membrane contains a minor proportion of the elastomer.

In embodiments of this method, the surface tension of the liquid material is selected, in relation to that of the solution, to provide pore characteristics in the produced membrane such that the membrane resists water droplets at a pressure equivalent to a 60 miles-per-hour wind, and/or to provide pore characteristics in the produced membrane such that the membrane can pass a quantity of water vapor of between 4,000 and 10,000 g/m²/day at normal human body and ambient temperatures, and/or to provide a pore size of between 100 and 1000 nm in the produced membrane.

The invention in further aspects contemplates the provision of a soft, porous hydrophobic membrane comprising a thin outer skin having small pores and a thicker layer beneath said skin having large pores, with a multiplicity of vacuoles formed immediately beneath said skin, produced by the foregoing method; and the provision of a breathable, waterproof fabric comprising a fabric layer having opposed surfaces, the aforesaid hydrophobic membrane fixed to a surface of said fabric layer, and a thin hydrophilic layer coated over the membrane skin A loose net material may be attached to the hydrophilic layer to prevent mechanical rubbing of the membrane.

By way of additional explanation of the invention, it may be noted that high water vapor evaporation throughput is the key for a high performance membrane. Traditionally a PVDF membrane is made of a solution containing no more than 20% solid PVDF in a solvent such as DMAC and a non-solvent bath of methanol alcohol. The membrane has generally a thin skin structure as described in Michaels '024 but with large pore diameter on the surface where it first contacts the non-solvent. A labyrinthine porous structure with decreasing average pore diameters lies beneath this skin. Porosity and maximum pore diameter are controlled by the amount of solid in the solution. The resulting membrane works well for a desalting application as a hydrophobic membrane but is very stiff and subject to breakage when folded.

The discovery leading to the present invention arose from preparation of a PVDF membrane using the same solid concentration with DMAC as solvent but with warmed water as the non-solvent. It was found that under these conditions, the membrane forms a thin skin with vacuoles behind the skin layer, and the membrane structure is sponge-like and under compression stress. No matter how sharply or how often one folds it or rolls it up it remains soft and strong without breakage.

It is further discovered that due to the vacuoles the flow rate is higher than in commercial membranes such as “Millipore”® membranes with comparable maximum pore diameters.

However, the process is not straightforward: when using water as non-solvent the compression stress reduces the surface pore diameter to about 0.1 micron and also reduces the number of pores on the thin skin surface so that the vapor flow rate is drastically reduced.

As patented by the present applicant (U.S. Pat. Nos. 4,419,242; 4,265,713; 4,316,772 and 4,419,187), to prevent contamination of the hydrophobic layer, a thin coat of hydrophilic layer is needed. The thin skin structure provides better texture for coating than the Gore membrane, which has nodes and fibrous structures.

It is further discovered that if the fabric can be slightly dissolved by the same solvent used for the PVDF then direct knife coating of the solution followed by dipping into the non-solvent bath fixes the membrane to the fabric without having to have a glue layer between fabric and PVDF membrane.

The following disclosure describes extensive research work covering all the membrane making parameters such as: solid concentration, type of solvent, the control of surface tension with respect to the solid used, the leaching time versus thickness, the bath temperature, the solution temperature, the drying temperature, the baking time, and baking temperature etc. This investigation resulted in establishment of the parameters which provide the smallest pore size at highest vapor flow rate and yet a form a membrane which is soft enough to provide the “hand” for fabric consumers.

It was also discovered that using a fluorine containing elastomer such as “Viton”® fluoroelastomer provides PVDF with additional elasticity. “Viton”® fluoroelastomer is soluble in the same solvent as used for PVDF and forms a porous structure together with the PVDF without being precipitated out as aggregated small lumps.

Further features and advantages of the invention will be apparent from the detailed description hereinafter set forth, together with the accompanying drawings.

### BRIEF DESCRIPTION OF THE DRAWINGS

FIG. 1 is a cross sectional view of an illustrative embodiment of the waterproof and breathable fabric of the present invention;

FIG. 2 is a diagrammatic illustration of the measurement of softness;

FIG. 3 is a diagrammatic illustration of the measurement of hydrophobic and hydrophilic characteristics of liquid on a solid surface;

FIGS. 4(a) and (b) are, respectively, Scanning Electron Microscope (SEM) pictures of an example of a PVDF membrane of the present invention and a Gore “Teflon”® ePTFE membrane;

FIGS. 5(a), (b) and (c) are SEM pictures of PVDF membrane with 15% solid concentration with DMAC as solvent, water as non-solvent: (a) the solid surface side of the membrane, (b) cross section and (c) surface layer;

FIGS. 6(a), (b) and (c) are SEM pictures of PVDF membrane with 15% solid in DMAC solvent, with 60% water and 40% methanol as non-solvent: (a) the solid surface side of the membrane, (b) cross section and (c) surface layer;

FIGS. 7(a), (b) and (c) are SEM pictures of PVDF membrane with 15% solid in DMAC solvent, with 0% water and 100% methanol as non-solvent: (a) surface layer, (b) cross section and (c) the solid surface side of the membrane;

FIG. 8 is a diagrammatic illustration of non-solvent surface tension forces interacting with solute during solidification (solvent with solid dissolved homogeneously);

FIG. 9(a) is a phase diagram for the gelation process of the Michael '024 solvent/non-solvent method for making a porous membrane, showing the solvent, non-solvent and polymer interactions;

FIG. 9(b) is a phase diagram of the gelation process described in the present application showing, in addition to the interactions of FIG. 9(a), mutual interaction surface tension and pre-stress control;

FIG. 10 is a graphical compilation of data on the factors that control the surface tension of the mixture and its effect on maximum pore diameter and porosity (as measured by N₂ flow rate at a given pressure difference);

FIG. 11 is a graph showing the effect of non-solvent bath temperature on membrane maximum pore size and porosity;

FIG. 12 is a photomicrograph illustrating the composite structure of a PVDF membrane coated with PVA as a hydrophilic coating;

FIG. 13 is a photomicrograph showing vacuoles as a means of extending membrane surface area;

FIG. 14 is a graph showing the effect on pore size of static soaking time in non-solvent bath;

FIGS. 15(a), (b) and (c) and FIG. 16 are graphs showing variation of maximum pore size (as measured by N₂ flow rate) on first surface with non-solvent surface tension, which is controlled by changing the proportion of water and methanol from 100% water (high surface tension) to 100% methanol (low surface tension); and

FIG. 17 is a highly simplified schematic view of a typical design of a fabric coating machine using mass transfer technology to set up a convective non-solvent bath such that there is a gradient of concentration of the solvent, wherein the solvent content is high at the entrance of the non-solvent bath and is low (or there is no solvent) at the exit end of the non-solvent bath.

### DETAILED DESCRIPTION

### Description of Drawings

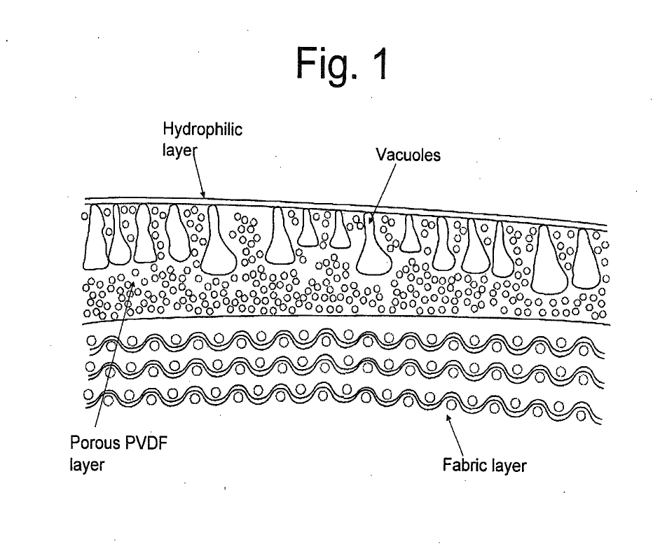

FIG. 1 illustrates the structure of an embodiment of the waterproof and breathable fabric of the present invention, including a fabric outer layer, a hydrophobic water vapor transmission layer, small pore surface structures on both sides to prevent water penetration, and a hydrophilic coating to which may be attached a net protection layer (not shown) to prevent mechanical rubbing. The outer layer fabric can be a woven or non-woven structure and may have a coating to prevent wetting. Under the thin porous layer are large vacuoles that improve vapor transmission.

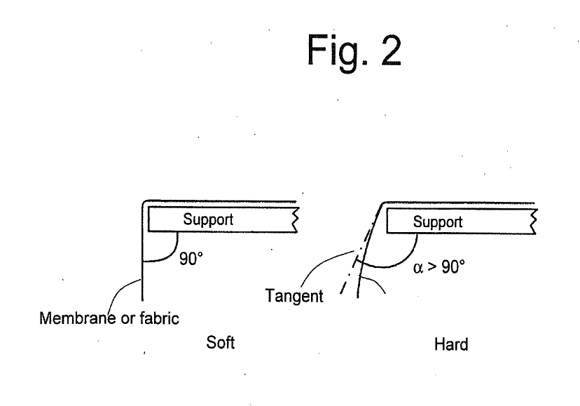

FIG. 2 illustrates a means of measuring the softness of fabrics. The softness is measured as the fabric's natural droop angle. A stiff membrane will stick out and very soft membrane will droop 90° downward. Most membranes droop at an angle between the two extremes. Therefore the angle of droop gives a comparison of relative softness.

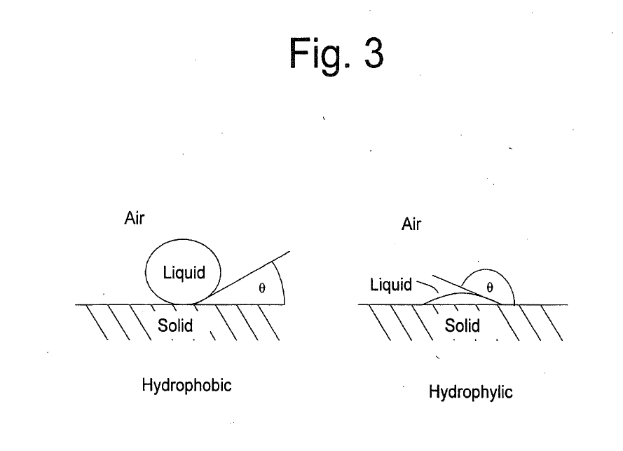

FIG. 3 is a diagram in explanation of the measurement of liquid-solid interaction. On the left is a hydrophilic solid and on the right is a hydrophobic solid. The contact angle is θ. If cosine (θ) is positive the surface is hydrophobic and if cosine (θ) is negative then the surface is hydrophilic. The surface tensions can be calculated according to Young's formula:

γ_{(b,s)}−γ_{(a,s)}=γ_{(b,a)}·cosine(θ).

wherein γ_{(b,s)} is the surface tension of fluid (liquid or gas) with solid, γ_{(a,s)} is the surface tension of solid with air, γ_{(b,a)} is the surface tension of fluid with air, and θ is the contact angle.

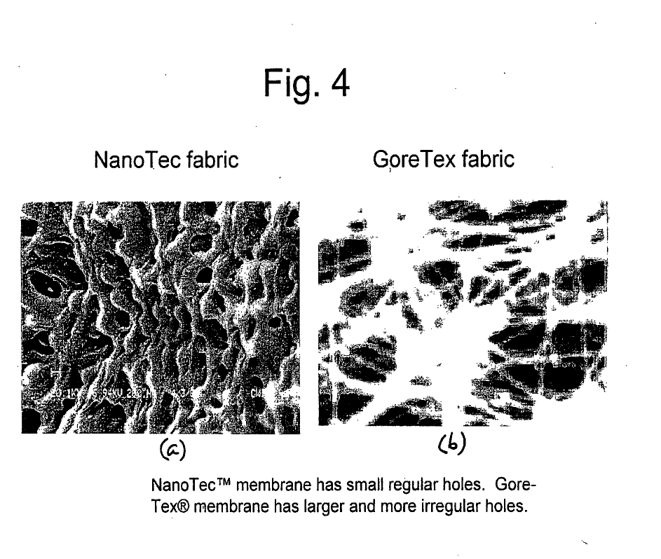

FIG. 4 compares a Scanning Electron Microscope picture of (a) the PVDF layer of an example of the fabric of the present invention with (b) the Gore “Teflon”® membrane used in “Gore-Tex”® fabric. The Gore membrane has a structure of fibers radiating from nodes, with several layers overlaid to obtain sub-micron average hole sizes. The typical holes are narrow and long lying between adjacent fibers. Assuming no displacement of fibers because of liquid pressure, the average pore diameter may be calculated on a hydraulic diameter basis. On the other hand the pores on the PVDF membrane are round and its hydraulic diameter is the actual diameter of the holes.

A droplet traveling at 60 miles per hour and striking a “Teflon”® membrane requires a pore diameter of 0.35 micron to penetrate. For PVDF the diameter is 0.31 micron. The surface tension unit is in dyne/cm.

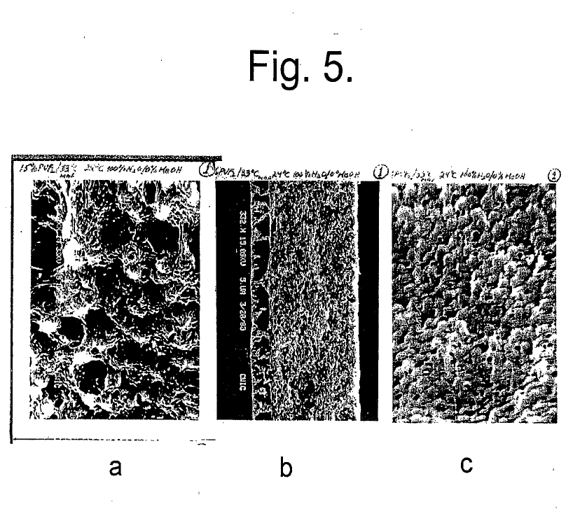

FIG. 5 shows SEM pictures of examples of PVDF membranes produced by a solvent/non-solvent technique when water is used as the non-solvent and the solvent is DMAC: (a) the surface in contact with a metal support on which the membrane was cast, (b) the interior structure of the porous media and (c) the surface first in contact with the non-solvent.

Water has a very high surface tension (75 dynes/cm), so the phase inversion process causes the material to form under compression. Mercury has the highest surface tension of all but mercury cannot co-mix with DMAC to pull solvent out of the solute. In (b), the cross section of the porous membrane, a strong thin skin layer can be seen. The contact with the non-solvent bath pulled solids to the surface and left behind a vacuolar structure which became solidified later in time. This vacuolar structure improves softness and vapor transmission but is not desirable for filter applications. In (a) the slow degradation of the diffusion process of solvent into non-solvent produces larger surface pore diameters and no thin skin layer. Good waterproofness depends on the small pore diameters of the porous interior.

The porous structure was solidified under compression so bending of the membrane essentially releases the pre-compression stress, which is why the membrane is soft. Since during the bending action no surface has been subjected to tension, the membrane is also tough and can be flexed repeatedly without breakage.

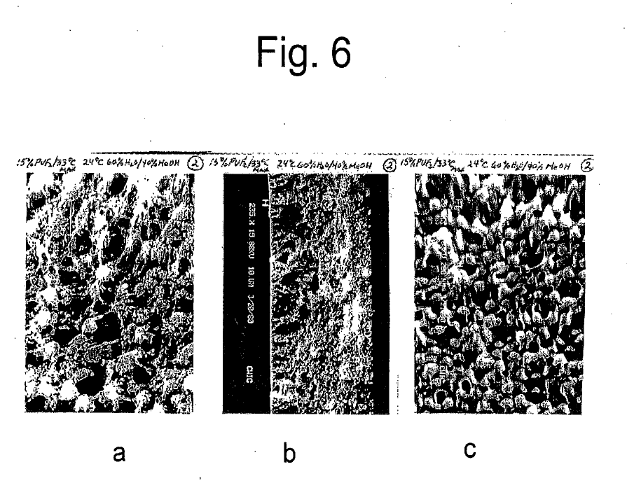

FIG. 6 shows a series of SEM pictures using 60% water and 40% methanol mixture as the non-solvent bath: (a) the so-called “matte” surface last to interact with the non-solvent, (b) the porous cross section, and (c) the surface first in contact with the non-solvent mixture. Methanol has the lowest surface tension (18 dynes/cm) besides ether (17 dynes/cm) but ether has very high vapor pressure at room temperature therefore the final amount of ether in the mixture can not be known precisely. With methanol as the low surface tension liquid and water as the high surface tension liquid, varying the concentration ratio provides a way of controlling the non-solvent surface tension. This allows pre-stressing of the membrane during solidification from compression all the way to tension.

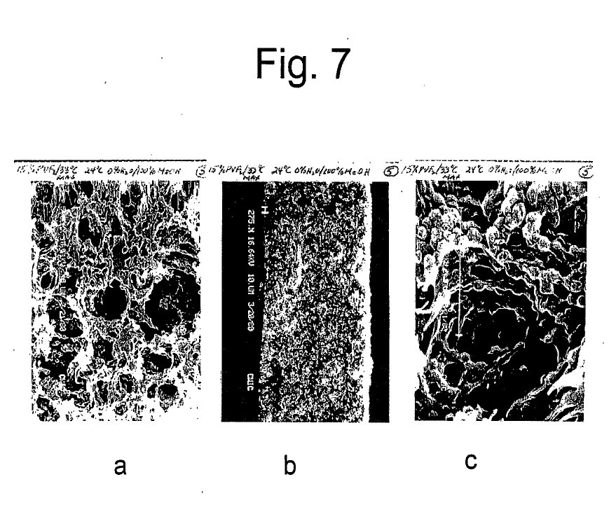

FIG. 7 shows the SEM pictures of a membrane in which the DMAC solution has been subjected to pure methanol alcohol: (a) the matte surface, (b) the porous structure, and (c) the surface first in contact with the non-solvent. There is no thin skin layer and the pores are relatively large. The membrane porous structure is subject to tension, so bending it adds tensile stress to the surface and it breaks. This membrane is as stiff as cardboard because of tension on the surface. This membrane is useful in filtration applications but is not suitable for fabric applications.

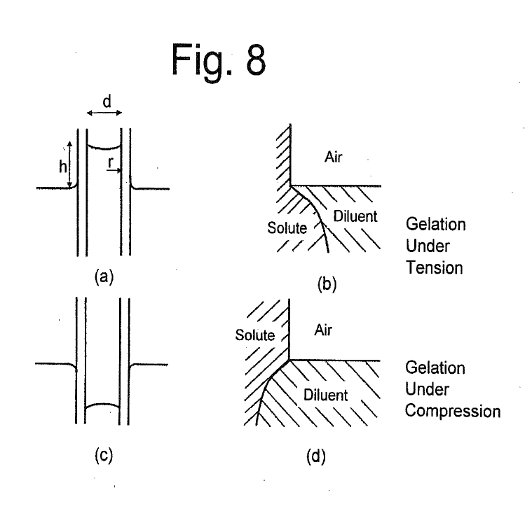

FIG. 8 illustrates the differences between hydrophobic and hydrophilic non-solvent interactions with solute. Normally the droplets that form on a solid surface manifest the hydrophobic interaction of a liquid with a solid surface. If the contact angle between the liquid and the solid is smaller than 90 degrees the surface interaction is hydrophobic; if it is greater than 90 degrees it is hydrophilic. It is commonly described in textbooks in terms of a capillary tube inserted into the liquid. If the liquid rises up the tube it is hydrophilic (FIG. 8a). If the liquid is pushed down then the tube material is hydrophobic (FIG. 8c). The contact angle and the height or depth that the liquid rises or sinks to in the tube gives a precise measure of the interactive surface tension between the liquid and tube material.

FIGS. 8a and 8c illustrate one of the ways of measuring the surface tension of liquid with a solid capillary tube. A hydrophilic interaction pulls a column of liquid up into the capillary tube and a hydrophobic interaction pushes the liquid down. The contact angle θ and the differential in liquid level h enable the surface tension to be calculated. The total weight of the column of liquid is ρghπr². The balance force due to interacting surface tension is equal to γ_{(b,s)} π d cosine(θ). Hence measuring h and θ with a known value of d gives γ_{(b,s)}.

When a solid material is dissolved in a solution which is in turn in contact with a non-solvent, and also if the non-solvent can absorb the solvent without limitation, then the solid will be precipitated from the solvent. The force of rejection between the solid and the non-solvent comes from the hydrophobic reaction between them and acts to compress the solids during gelation. Thus there is compression pre-stress on the resulting solid porous structure (FIG. 8d). On the other hand, if the non-solvent is hydrophilic and subject to a force of attraction between the precipitated solid surface and the non-solvent then the solid is pulled away from the solute and the porous structure is subjected to a tension force (FIG. 8b).

Thus changing the surface tension of the non-solvent will affect the porous structure of the membrane. It was found as illustrated here that a pure water bath having the highest surface tension against PVDF produces a compression structure and a thin skin and vacuoles. The maximum pore size in the skin layer is very small even though the porosity is dense. The average pore size is also small which gives low vapor transmission (measured as N₂ flow at a given pressure differential). Such a material may have filter applications but is not suitable as a highly breathable membrane for clothing. The structure is shown in FIG. 5. At the other extreme, when the non-solvent bath is pure methanol, the membrane structure is subjected to tension. No thin skin is formed. The pore size on the surface is very large and the porous structure is highly permeable to vapor. One problem is that the membrane is at maximum tension so a slight folding of it would over-stress its surface and cause breakage. Another problem is that the pore size is too large to be an effective barrier to water droplets. The large pores are also difficult to cover with a hydrophilic layer. FIG. 6 illustrates an intermediate case in which a controlled non-solvent surface tension yields a maximum pore size of less than 0.3 micron but is still highly porous: the permeation rate as measured by N₂ flow is about 55 to 60% that of material produced in the pure methanol bath but has similar pore size to that produced in the pure water bath (but with many more pores on the surface), giving a N₂ flow rate many times greater than that of the pure water bath membrane. Thus is exemplified the feature, in the present invention, of a “controlled surface tension non-solvent bath” in which PVDF solids are precipitated to form a membrane with good flow rate and a pore size of no greater than 300 nanometer, and soft enough to give a good “hand” for fabric applications.

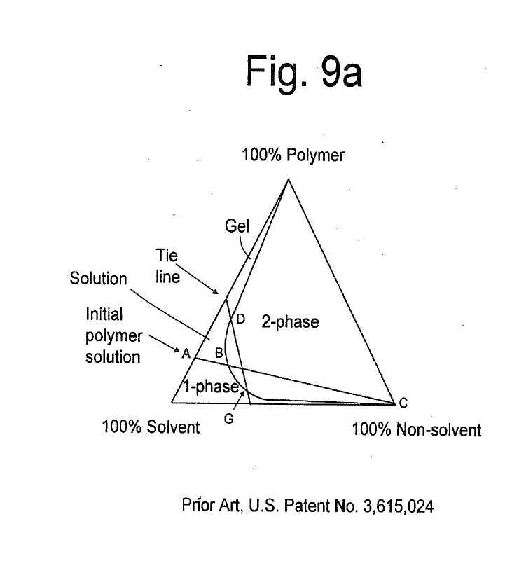

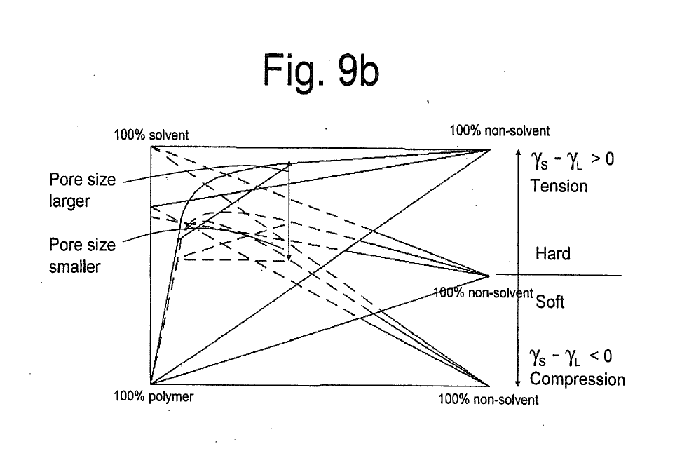

FIG. 9(a) is the classical phase diagram from Michaels '024 for the solvent/non-solvent gelation process for a porous membrane. The process starts with a polymer solvent solution at point A. When this is then dipped into a non-solvent the process follows a path (the details of which depend on the rate of diffusion and the properties of the non-solvent) indicated by the line A-B. At B the mixture reaches a boundary where it becomes two-phase (liquid and gel) and becomes a porous structure. The gel part of the mixture then moves from B to D at which point the polymer can no longer be dissolved into the solvent as the limit of a concentration has been reached. The liquid phase moves from B to G.

FIG. 9(b) illustrates the complete relationship of the solvent /non-solvent process as a 3-dimensional phase diagram. The surface tension of non-solvent with respect to the solution of solvent and polymer affects the porous structure. Basically, it uses Michaels' diagram as the equilibrium plane, and this is tilted upwards if the surface tension of the non-solvent is less than the solute surface tension: the pore sizes will be larger and the membrane is under tension and becomes hard and stiff. On the other hand if the non-solvent surface tension is greater than the solution surface tension, Michaels' triangle is projected downward, the membrane is under compression so the pores are in general smaller and the material is softer.

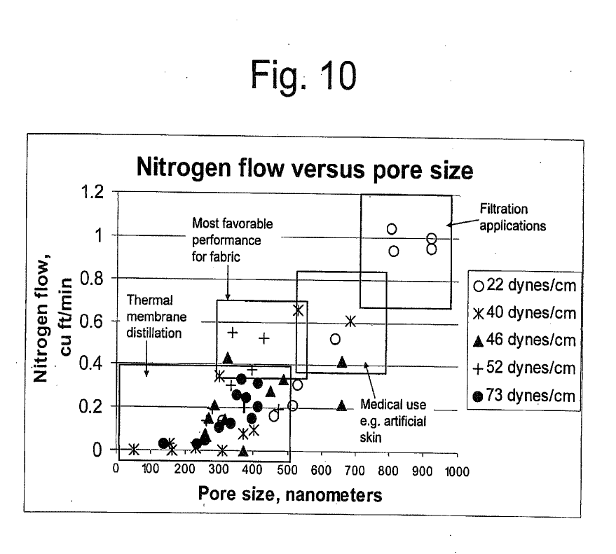

FIG. 10 is a compilation of data created by varying the solid concentration in DMAC, the solute temperature, water temperature, and the mixture of water and methanol from pure methanol to pure water. Maximum pore size and N₂ flow rate are measured at a constant pressure differential of 15 psid. Depending on the need the membrane can be highly waterproof and soft or have a high N₂ flow rate and be less waterproof and stiff. The compiled data is used as an illustration only.

In the following Tables, Table I gives a list of solvents that can be used to dissolve PVDF. Table II is an example of non-solvents with their surface tensions. These can be used as non-solvents for the PVDF but yet dissolve well in the solvents.

TABLE I
List of solvents that can be used to dissolve PVDF

| Solvent | Surface tension |
|---|---|
| DMAC (N,N,Dimethylacetamide) | 32.43 at 30 deg C. |
| MEK (2-Butanone; Ethyl methyl ketone) | 24.6 at 20 deg C. |
| DMF (N,N,Dimethylformamide) | 36.76 at 20 deg C. |
| THF (Tetrahydrofuran) | 26.4 at 20 deg C. |
| NMP (1-methyl-2-pyrrodidone; M-pyrol) | |
| Trimethyl phosphate | |
| Tetramethylurea | |

TABLE II
List of non-solvents which can be used to absorb
solvents from the dissolved PVDF solution

| Non-solvent | Surface tension |
|---|---|
| Methanol | 22.61 at 20 deg C. |
| Ethanol | 24 |
| Isopropanol | 21.7 at 20 deg C. |
| Butanol | 24.6 at 20 deg C. |

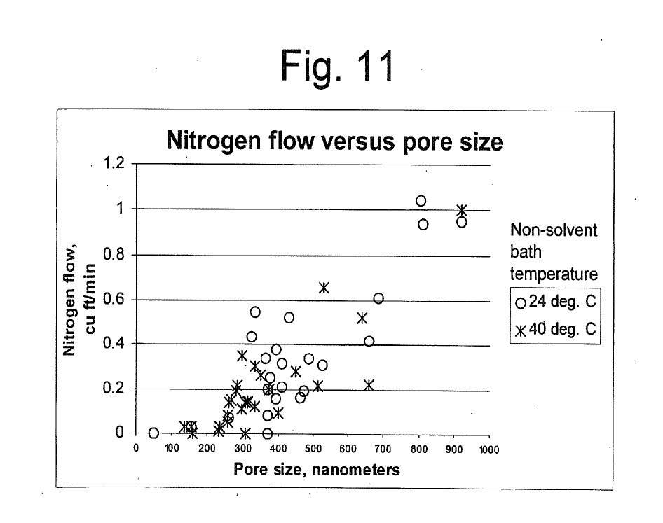

FIG. 11 is a compilation of the maximum pore sizes and N₂ flow as a function of the non-solvent bath temperature. It is known that water surface tension is inversely proportional to temperature. Temperature is also a measure of average molecular motion—low temperature means low average molecular motion and therefore slows diffusion. This is in contrast to the description in Michaels '024.

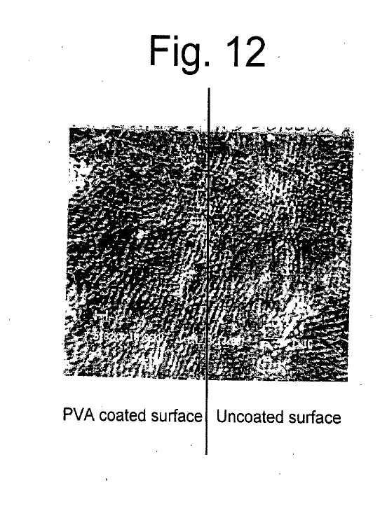

FIG. 12 is a comparison of PVA (polyvinyl alcohol) coating over PVDF membrane on the left and non-coating on the right. The picture illustrates that vapor permeation is not only influenced by the maximum pore sizes, but is also a function of porosity on the surface and of porous structure. The PVA coating covers the opening of the pores and has higher burst strength, which further increases the practical waterproofness of the membrane. Best performance seems to occur at a maximum pore size of 300 nanometers. One can also see that the pores are round, unlike the irregular pores of the Gore membrane.

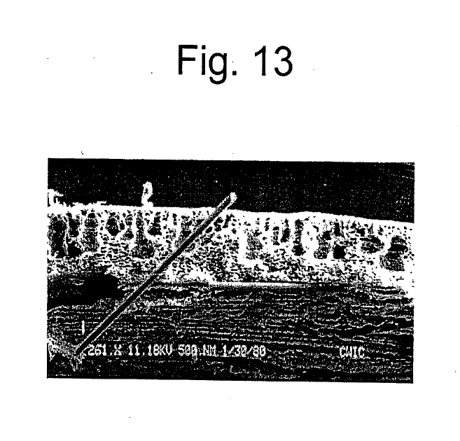

FIG. 13 shows a cross section of the fabric, which has a PVDF porous layer in which large vacuoles are embedded to form an extended surface, and with a PVA hydrophilic coating. This is just an example of what can be manufactured.

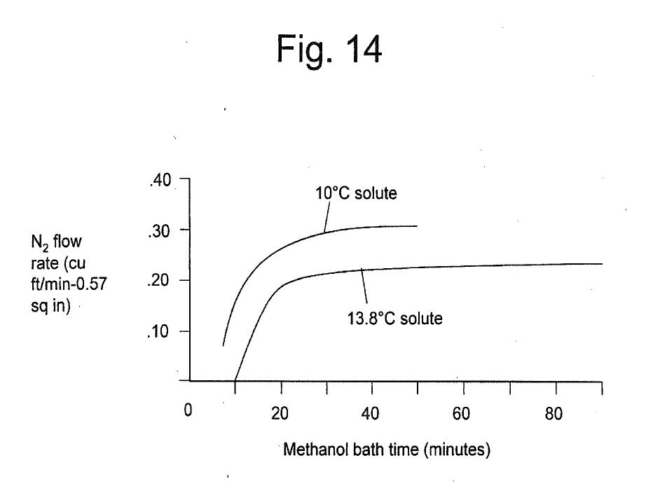

FIG. 14 shows the effect of soaking time during membrane gelation in the non-solvent bath. Gelation is a diffusion process in which the solvent is pulled from the solute leaving the gel behind to form a membrane. This illustrates that the soaking time affects the final porous structure. In this example the process only allows the non-solvent to penetrate the solution from one side. In the case of a coating on a fabric the non-solvent may enter from both sides and so the soaking time will be cut in half. Thinner coatings also will cut down the diffusion time. Finally, mass transfer is similar to heat transfer in that under convective conditions the soaking time is dramatically reduced.

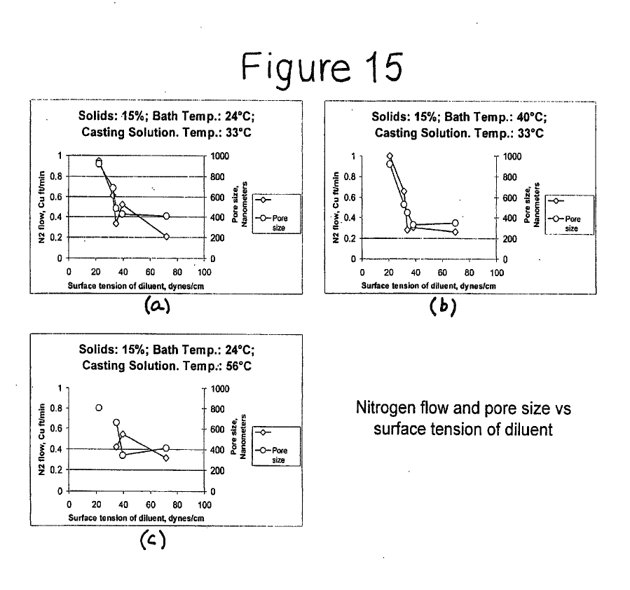

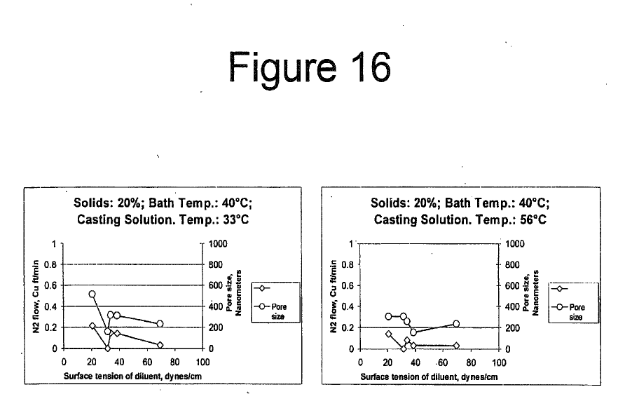

FIGS. 15(a), (b), and (c) and FIG. 16 are typical examples of N₂ flow for a given solid concentration (15% in FIG. 15, 20% in FIG. 16) versus different mixtures of water and methanol varying from pure water to pure methanol in a non-solvent bath. The resulting small pore size of less than 0.1-micron diameter obtained when using pure water provides high water resistivity but with slower N₂ flow under differential pressure. It is however very soft. With pure methanol and no water the pore size approaches that of 1.0 micron and N₂ flow is high but the membrane is under tension and is therefore subject to breakage. As shown in the plot somewhere in between the maximum pore diameter is about 9.3 microns and there is still with fairly high N₂ flow. Fabric made with intermediate mixtures of solvent and non-solvent has reasonable elasticity.

From the above figure, it can be seen that the effect (described in FIG. 9(b)) of a high surface tension non-solvent going towards a low surface tension is to cause the pore size to increase and pore density to decrease (as shown by an increased nitrogen flow rate), with a remarkable dip in pore size and nitrogen flow rate at the point of transition into a membrane with skin layer. Beyond this point it goes back to larger pore size and nitrogen flow rate. The dip occurs at about the solute surface tension as illustrated in FIG. 9(b). It is also interesting to see that the preparation of the solution involves a memory effect in that when the solution was prepared at higher temperature (say 56° C.) the casting, even if done at room temperature, has a pore size smaller than that from the solution prepared at 33° C. The higher non-solvent bath temperature changes the pore size and porosity, indicating that the diffusion rate of solvent into the non-solvent can be controlled by the bath temperature. At high solid content the dip occurs closer to the solvent surface tension and the dip effect is less pronounced.

The walls that form around the bubbles have to be broken down in order to allow vapor or nitrogen gas to flow. When the non-solvent and solution have the same surface tension, the force to pull the web apart either by tension or by compression is not there, resulting in a complete bubble structure with no communication between them.

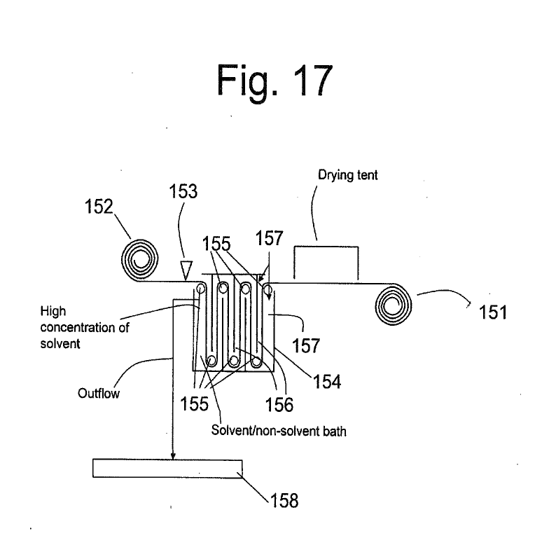

FIG. 17 illustrates a typical design of a fabric coating machine. It uses mass transfer technology to set up a convective non-solvent bath such that there is a gradient of concentration of the solvent. The solvent content is high at the entrance of the non-solvent bath and low or no solvent at the exit end of the non-solvent bath. A low surface tension solvent for PVDF and “Viton”® fluoroelastomer can prevent rapid solvent diffusion and immediate gelation. As the non-solvent penetrates the coated film it is desired that the solvent content in the non-solvent mixture diminish at a constant rate so that the porous structure remains as uniform as possible. By controlling the rate of diffusion one can control the pore size, the porosity and the softness of the membrane and final fabric.

This simplified figure describes the entrance of the coated fabric into the non-solvent bath at the end where there is a high concentration of solvent, this being controlled by drainage of the non-solvent bath (sometimes called the developer bath), and pure non-solvent is added to the developer tank at the other end where coated fabric or membrane is being taken out of the developer tank and going into a drying tunnel. The amount of pure non-solvent liquid is monitored to keep the tank liquid level constant. For example, if the non-solvent is methanol (which has a very low surface tension), it enters the developer tank at the fabric exit end and if the solvent is DMAC this is mixed into the methanol by diffusion. The high concentration of DMAC increases the surface tension of the non-solvent in situ such that the surface tension is higher than the pure methanol liquid, so the resulting porous membrane has less tensile stress and smaller pore size and is softer.

As another example, if the non-solvent is pure water, then where the coated film enters the developer tank the solvent (e.g. DMAC) with a relatively high concentration will lower the surface tension of water and also therefore the compressive stress at the membrane surface so it will not form a very tight skin surface with very small pores; instead it will have moderate pore diameter with high porosity. The membrane still has a degree of softness suitable for clothing purposes.

In FIG. 17, 151 is the roll of fabric, 152 is the fabric under tension to be coated. 153 is the knife coater and 154 the non-solvent tank or developer tank. 155 represents a number of rollers guiding the coated fabric under tension submerged in non-solvent liquid; 156, a number of baffles guiding the non-solvent flow in the opposite direction of fabric flow; 157, the non-solvent feed; and 158 is the solvent recovery process.

### Description of the Invention

A new PVDF membrane making method is designed to have pore sizes under control from nanometer range to 10 microns in hydraulic diameter with a sponge like structure without articulated walls, stressed in a slightly compressed mode so that when flexed it is not subject to tensile stress and so does not break.

The sponge structure should be more than 50% empty so that it is highly vapor permeable. Under a thin skin at the exit side of the membrane the structure has large pockets which increase its effective area so that it is highly permeable to water vapor. The thin skin prevents the entry of liquid water. Unlike “Gore-Tex”® material, this membrane is directly coated over the fabric and is not glued to it. It is also softer. A thin hydrophilic layer is coated over the PVDF membrane as described in the present applicant's previous U.S. Pat. Nos. 4,419,187; 4,476,024; 4,419,242; 4,265,713; and 4,316,772, and optionally a net protection layer on top of that.

Prior art solvent/non-solvent membrane making is according to the teachings of Michaels '024 as seen in FIG. 1 thereof. Successful membrane making is in the relationship between the concentration of solids in solvent and percentage of solvent being removed by the non-solvent. The solvent can be a mixture of more than one liquid. The non-solvent is chosen to be very miscible with the solvent, with strong mutual diffusion coefficients.

What was not addressed by Michaels '024 was the proportion of solvent /non-solvent and the surface tension of the non-solvent relative to the solid solution.

Typically the non-solvent is methanol or ethanol, which are hydrophilic to PVDF. The solvent is an organic compound such as DMAC or DMSO (see Table 1). The solidification process pulls away the solvent so quickly (the leaching process) that pores form on the surface layer. The porous structure is highly stressed under tension, resulting in a strong but brittle membrane with larger pore diameters.

If the non-solvent is water (which is highly hydrophobic with respect to PVDF) the solidification process removes solvent and puts the porous structure under compression. A skin layer is formed with small pore sizes and with vacuoles underneath which extend the vapor permeation surface area. The rest of the porous structure is under compression so when the membrane is folded this releases the compression stresses and the membrane becomes soft and pliable. The diffusion rate between the solvent and non-solvent is found to be temperature dependent and solid concentration dependent. The resultant membrane is dense in structure and is not as porous.

It is further discovered that the process can be controlled by mixing methanol or another hydrophilic non-solvent with water or another hydrophobic non-solvent such that the surface tension of the non-solvent mixture against the PVDF solution imposes various degrees of stress on the membrane structure all the way from compression to tension. In addition with variations in solid concentration, the solute temperature and non-solvent surface tension and temperature, pore size and pliability can be controlled as specified by the customer. This allows production of a PVDF membrane with better breathability and more waterproof than in the “Teflon”® ePTFE structure.

The invention is further illustrated by the following hypothetical examples:

### EXAMPLE 1

PVDF powder in the range of 10% to 20% solid content is dissolved in a mixing vessel with one of the solvents listed in Table I. PVDF is in powder form. Adding solvent over powder under cover of the vessel with a stirring mechanism should perform the mixing. The solution should be thoroughly stirred until there is no sign of any solid powder. The solution usually is filtered through a fine mesh and then pulled into a degassing vessel by a vacuum pump. The air is then let in which compresses the solution. This process is repeated until there is no rise of the liquid surface (because of de-gassing) under vacuum.

The pre-mixed solution has a fairly good shelf life if it is kept sealed to avoid any moisture penetration.

If fabric is to be coated, the fabric is pre-cleaned and all the particles and unwanted fine fibers sticking out are removed. The fabric is loaded on a knife coating machine to be coated. The solution of PVDF is fed to the knife coater as the fabric is pulled through it. The fabric is coated to a pre-determined thickness that may be automatically controlled. The coated fabric is then dipped into the non-solvent solution. The fabric is soaked long enough to thoroughly remove most of the solvent and is then fed into a drying channel under tension. After that it is ready for more treatment such as the addition of a hydrophilic coating, a net structure, or a spray-on a water repellent such as “Scotchgard”®. The fabric can then be rolled up for shipment or storage.

### EXAMPLE 2

The non-solvent is water and the solvent is for example DMSO or DMAC. This causes a reduction of the surface tension of the non-solvent and so of the diffusion rate of the solvent from the solution.

### EXAMPLE 3

The fabric is fed in at the end of the non-solvent bath where the solvent content is high. By the time it reaches the other end of the developer tank the solvent concentration is approximately zero, so all the solvent is removed from the fabric. The fabric is then fed into a drying tent to remove all the non-solvent. The solvent content is controlled by drainage from the fabric-feeding end of the tank.

Experience has shown that if the fabric is fed through a highly hydrophobic non-solvent bath it should be under strong compression because the compression force of the porous structure during gelation causes shrinkage Once it is gelled the wrinkled surface cannot be stretched without some damage.

If the non-solvent bath is hydrophilic the fabric still needs high enough tension so that the porous structure can be relieved of its stress once the fabric tension is removed.

### The Preferred Embodiment of the Method and Product

A preferred embodiment of the invention is a method using non-solvent surface tension and concentration of a solid of a hydrophobic material dissolved in a solvent to produce a hydrophobic porous membrane or a coated layer on a fabric. The surface tension of the non-solvent is used to control the maximum pore diameter, the porosity and pre-stress in the porous structure for softness control. A possibility is to use a low surface tension solvent mixed with the high surface tension water as a means for surface tension control. Another method is by controlling the developer bath temperature as most liquids have lower surface tension at higher temperature.

Another step in the process is to leach the solvent out of the solution of solute and solid by mixing with the non-solvent in situ so that a solvent concentration gradient is set up which controls the rate of solvent diffusion out of the solute during the gelation process. This keeps the porosity constant.

Using PVDF as the hydrophobic material, this process can be controlled so that the maximum pore diameter will fall in the range of 0.05 to 1.0 micron. By varying the solid concentration in the solution, other desired pore diameters can be made also.

The PVDF membrane is developed in a high water concentration non-solvent liquid such that the resulting membrane will be under various degrees of pre-stress and under compressive force, which is how the membrane is made soft.

Solid concentration in the solvent can be varied from 10% to 25%; as a result the porosity can be varied as desired.

To make the porous structure uniform, a constant diffusion rate of the solvent is needed. The non-solvent bath temperature should be low to produce uniform small pores with sufficient latitude of solid concentration from 12.5% to 17%.

The pores should be as round as possible so that a hydrophilic coating can be applied without causing pore contamination.

To be waterproof with a 60 mph raindrop velocity the maximum PVDF membrane pore size should be under 0.3 micron.

To be waterproof to 100 mph raindrop velocity the maximum pore size should be 0.15 micron for a PVDF membrane.

Breathability of the membrane should be greater than at least 4,000 g/m²/day, preferably in the range of 5,800 g/m²/day to 15,000 g/m²/day.

As a coated fabric the breathability should be greater than 3,600 g/m²/day and waterproof at a 100-psia static pressure and soft enough to pass U.S. Army uniform specifications.

As the best performance fabric the waterproofness should be better than 60 mph rain drop velocity and breathability should be over 6000 g/m²/day.

### Applications

A hydrophobic membrane made of PVDF and other hydrophobic plastics instead of “Teflon”® resin has many applications as described below:

1. One of the biggest advantages of the PVDF membrane is that it can be molded into different shapes to provide a waterproof and breathable partition. In particular, it can be used as an artificial skin for dressing skin wounds. Most bandages have small holes outside the cotton cheesecloth pad for the wounds to breath. It is a problem if the patient has a large skin area damaged, such as with a burn patient. First the dressing should not stick to the wounds because changing dressings can be a very painful experience. Second, the area should allow water to evaporate so appropriate healing can take place naturally without additional swelling. The artificial skin can prevent foreign objects unintentionally touching the wounded surface and so prevent germs from accumulating. The wounded surface of a body has very unusual contours. “Teflon”® membrane has to be prefabricated and is difficult to fit to a certain contour. With the above described solvent/non-solvent membrane making process, a coating of solvent with PVDF can be applied to the skin and immediately washed by a non-solvent, preferably water. The solvent should be non-toxic, for example DMSO, and the most appropriate non-solvent is water. DMSO penetrates human skin with a very high diffusion rate. Sometimes a mixture of a drug and DMSO is used to allow the drug to penetrate into the body without injection. One of the side effects of DMSO is to make the patient immediately taste garlic in their mouth. If this process is carried out very quickly, and the patient drinks a large quantity of water, DMSO should be discharged from the body. DMSO at one time was considered to be helpful in reducing swelling of joins in arthritis patients. This artificial skin forming in situ on the burnt skin is like a cast on broken bones. The body temperature drives the water out of the micropores and leaves the hydrophobic membrane.

2. Because of its hydrophobic nature, PVDF porous membranes can be used in air filters, for example as the air intake filter of an automotive engine or even more appropriately as the air intake filter for small airplane engines. The membrane would have a non-woven paper backing and would not allow water in droplet form to enter the intake manifold.

3. An extra thin coating of PVDF on a thin paper backing could replace cloth curtains used in hospitals around a patient's bed. This would reduce contamination by germs, which tend to attach to hydrophilic surfaces. In the event of being soiled by drugs or other fluids the curtain could be thrown away.

4. This PVDF membrane can be stitched using ultra-sound which is not true of the “Teflon”® membrane. A PVDF membrane bag filled with water could be used to maintain the moisture content of a package. Certain food products have a drying agent to keep the package dry and the food crispy and tasty. On the other hand, there are also foods which need to be kept in a moist atmosphere. For example, bread and fresh fruit would benefit from a sealed water-filled bag made of PVDF to keep them fresh and moist. Other examples are packaging of flowers for shipping a long distance away: too much water and the cargo is too heavy, not enough moisture and the flowers will dry out. Similar considerations apply for exotic fruits and vegetables.

5. The membrane can be used to package time-release drug patches. It is difficult to find materials that will not interact with the drug and its solvent based chemicals. As long as the solvent-based chemicals do not interact with PVDF, there will be no problem. Fortunately (see Table 1) only a very limited number of chemicals dissolve PVDF.

The above examples are only a few of all the possible applications. This product is by no means restricted to the application of the above-cited examples.

### Discussion

Highly breathable and waterproof fabric is desirable for rain gear, sports clothing, shoe covering, hats etc. Several attempts have been made to produce a fabric that is soft, porous and waterproof using PVDF as the hydrophobic material but these were not successful. This invention, based on years of data compilation, allows one to control the pore diameter, porosity and softness. “Viton”® as a flouroelastomer can be added to PVDF to soften the membrane, but “Viton”® elastomer is very expense so a combination of the correct non-solvent bath surface tension with little or no “Viton”® elastomer should be used. Depending on the degree of softness required, other plasticizers can be used such as long chain di-carboxylic acid esters with a “springy” structure, such as Dibutyl sebacate, Dioctyl adipate and others; they do not degrade the hydrophobic properties of PVDF very much. This provides an ideal fabric which is waterproof and highly breathable, with sufficient softness to be a quality fabric but much cheaper than a “Teflon”® based fabric. “Teflon”® material has a slight advantage in that it has a lower surface tension than PVDF but no solvent can dissolve “Teflon”® resin so it has to be produced by physical means and therefore at a high cost. The PVDF fabric not only costs less to produce, but outperforms the “Teflon”® based fabrics. One of the reasons is that, as described above, the present invention enables total control of pore size range and also of fabric softness. Also, the “Teflon”® based fabric has to use glue to laminate the final fabric structure. The pre-stress control during membrane gelation of PVDF gives the final product as desired.

In summary, the invention provides, inter alia, a method whereby a membrane is made out of PVDF or similar relatively inert plastic using a solvent/non-solvent process, in which pore size and other structural characteristics can be controlled by varying parameters such as solvent/non-solvent concentrations, casting bath temperature, solvent/non-solvent bath temperature, percent solids and bath time, and wherein small quantities of an additive (“Viton”® fluoroelastomer) may or may not be added to improve elasticity. The method of the invention can produce a soft fabric suitable for clothing. It can make a hydrophobic membrane that can be coated directly onto fabric without requiring intervening glue, and/or can also be stitched. A hydrophobic membrane can be produced that is able to resist water droplets at a pressure equivalent to a 60 mile per hour wind; that can pass a quantity of water vapor of between 4,000 g/m²/day and 10,000 g/m²/day at normal human body and ambient temperatures; and has pore size of between 100 nm and 1000 nm. Moreover, by the method of the invention there can be produced a membrane that is highly hydrophobic, but is covered with a very thin hydrophilic layer, which does not affect breathability of the membrane but does improve waterproofness.

It is to be understood that the invention is not limited to the features and embodiments hereinabove specifically set forth, but may be carried out in other ways without departure from its spirit.

What is claimed is:

1. A method of producing a porous membrane comprising a hydrophobic membrane including an outer layer having pores and a support layer having porosity beneath said outer layer, and a hydrophilic layer coated on said outer layer, said method comprising the steps of:
(a) providing a solution of a membrane-forming polymer as solute in a solvent therefor,
(b) establishing a film of the solution,
(c) bringing a liquid material including a non-solvent for the polymer into contact with the film so as to leach solvent from the solution and cause gelation of the polymer to form the hydrophobic membrane, and
(d) coating a hydrophilic layer over said outer layer of said hydrophobic membrane,
wherein the providing step comprises selecting an amount of solute in said solution to control maximum pore size of said pores of said outer layer, and the bringing step comprises selecting the liquid material to control said porosity of said support layer by controlling the surface tension of said liquid material in relation to the surface tension of said solution so as to control stress to which the membrane is subjected during gelation, wherein said non-solvent comprises a mixture of at least two liquids which are non-solvents for the polymer, wherein the surface tension of the liquid material is controlled as aforesaid by selection of relative proportions of said two liquids in the liquid material, and wherein said liquid material has a surface tension greater than that of said solution and said membrane is subjected to compression stress during gelation.

2. A method according to claim 1, wherein said polymer forms a hydrophobic membrane.

3. A method according to claim 2, wherein said solvent and said non-solvent are miscible.

4. A method according to claim 2, wherein said polymer is PVDF.

5. A method according to claim 4, wherein said solution further includes a fluorine-containing elastomer in an amount such that the formed membrane contains a minor proportion of said elastomer.

6. A method according to claim 4, wherein said solvent is DMAC, DMSO, MEK, DMF, THF, NMP, trimethyl phosphate or tetramethylurea.

7. A method according to claim 4, wherein said non-solvent comprises a mixture of water and at least one liquid selected from the group consisting of methanol and ethanol.

8. A method according to claim 7, wherein relative proportions of water and said one liquid in the liquid material are such that said liquid material has a surface tension greater than that of said solvent, thereby subjecting the forming membrane to compression stress during gelation.

9. A method according to claim 8, wherein the solvent is DMAC, DMSO, MEK, DMF, THF, NMP, trimethyl phosphate or tetramethylurea.

10. A method according to claim 1, including mutually selecting the liquid material and the amount of solute in the solution such that pore size of said outer layer is smaller than pore size of said support layer.

11. A method according to claim 10, wherein said outer layer is a thin skin and said support layer is thicker than said skin and has a multiplicity of vacuoles formed immediately beneath said skin.

12. A method according to claim 1, wherein the hydrophilic layer comprises PVA.

13. A method according to claim 12, wherein said polymer is PVDF.

14. A method according to claim 1, wherein the hydrophilic layer is thin in relation to the hydrophobic membrane.
